(19) United States
(12) Patent Application Publication
(10) Pub. No.: US 2021/0364892 A1
(43) Pub. Date: Nov. 25, 2021

(54) METHOD AND APPARATUS FOR RETAINING AN ELECTRONIC DEVICE

(71) Applicants: Max Abergel, Thornhill (CA); Juaquin James Malphurs, (US)

(72) Inventors: Steve A. Copeland, Barrie (CA); Nicholas Teixeira, Angus (CA); Max Abergel, Thornhill (CA); Mitchell Thompson, Sudbury (CA); Daniel Kowalewski, Bailieboro (CA)

(73) Assignees: Max Abergel; Juaquin James Malphurs

(21) Appl. No.: 16/879,891

(22) Filed: May 21, 2020

(51) Int. Cl. G03B 17/56; A45D 42/00; G03B 15/02; F16M 11/14; F16M 11/20; F16M 13/02; H04N 5/232

(52) U.S. Cl. CPC G03B 17/561; A45D 42/00; G03B 15/02; F16M 11/14; F16M 2200/068; F16M 13/022; H04N 5/23216; F16M 2200/022; F16M 11/2078

(57) ABSTRACT

A lighted makeup mirror including a bar that forms part of a frame circumscribing and supporting a mirror assembly that has opposed mirror panels of different magnifications. A clamping device is engaged with the bar and is selectively movable therealong. The clamping device temporarily secures an electronic device, such as a smartphone, to the mirror. The mirror has a processor including programming which allows the mirror to be paired to the electronic device. A user interface on the mirror allows a user to control the functions of the mirror and of electronic device. The user manipulates the user interface to shoot selfies or videos with the electronic device while illuminating their face with the mirror. The electronic device is movable and tiltable relative to the mirror so that the user is able to obtain a desired shot of them applying makeup or styling their hair.

### TECHNICAL FIELD

This disclosure is generally directed to beauty products. More specifically, this disclosure relates to makeup mirrors. The disclosure is particularly directed to an electronic makeup mirror capable of supporting an electronic device in a number of different orientations and which may be wirelessly paired to the electronic device in order for a user to illuminate themselves, take a selfie, and/or shoot a video with the electronic device while using their hands to apply makeup or style their hair.

### BACKGROUND

### Background Information

Makeup mirrors have been available for many years to assist women when applying their makeup. Typically, these mirrors include a base with a vertical stand upon which a support bar is mounted. A double-sided mirror is engaged with the support bar and is held a distance above the stand. Typically, one side of the mirror provides 1× magnification and the other side of the mirror provides some type of zoom magnification. For example, the second side of the mirror may provide 5×, 7×, or even 10× magnification. The mirror is able to swivel about an axis in order to present one or the other of the two sides of the mirror to the user.

Makeup mirrors are frequently provided with some type of lighting so that the user is able to illuminate their face while applying makeup or styling their hair. The lighting may take the form of a Light Emitting Diode ring (LED ring) that circumscribes the perimeter of the mirror. In some instances, the LED ring form parts of the support bar while in other instances, the LED ring is provided on one or both sides of the mirror itself. Typically, these mirrors include a mechanism for switching the LEDs on or off, or for increasing or decreasing the level of light emitted by the mirror.

In recent years, makeup mirrors have become electronic devices that provide other features that a user may desire. The HOME® VANITY MIRROR, for example, is provided with electronics that enable a user to pair their cell phone with the mirror and play music through a speaker provided on the mirror base. (IHOME® is a registered trademark of SDI Technologies Inc. of Rahway, N.J., US.) The user may connect their phone wirelessly to this mirror or may engage a cable in a specially-provided port on the mirror base. The user may even receive phone calls through the electronics provided on the mirror. If the user hears their cell phone ring, they can simply depress a button provided on the mirror base to accept the call and can depress the button again to end the call.

More recently, women are using their makeup mirrors and their cell phones to take selfies of their hair and makeup. Many are also creating video tutorials utilizing showing them applying makeup and styling their hair. Actually making these video tutorials can be extremely challenging as the cell phone has to be held for filming while the user is trying to apply their makeup or style their hair. In some instances, the cell phone is also used to help illuminate the user from different angles so that the viewer can readily see the application of the makeup, the styling of the hair, and/or the finished product.

Devices have been proposed in the prior art to help the user correctly position and hold a cell phone while making a video using a makeup mirror. Devices such as those sold under the brand name of YEFOUND® and MACTREM® are examples of these devices. (YEFOUND® is a registered trademark of Shenzhen Huatong Taiyuan Technology Co., Ltd of ShenZhenCity, Guangdong, CHINA.) MACTREM® is a registered trademark of Shenzhen Zhonghe Network Technology Co. Ltd. of LongHua New Dist Shenzhen, Guangdong CHINA.) The YEFOUND® device includes a tripod that is able to be positioned on a flat surface. A selfie ring light is provided at an upper end of the tripod and the ring light surrounds a swivelable makeup mirror. A smartphone mounting is provided on the tripod shaft and is able to be moved vertically upwardly or downwardly along the tripod shaft to position the user's smartphone. The tripod shaft telescopes to enable the user to change the length of the shaft. The device also includes a remote that may be paired with the user's smartphone so that the smartphone's camera may be operated from a distance away from the device. The MACTREM device includes a U-shaped holder positioned at the top of a tripod. A selfie light ring is engaged on one arm of the U-shaped holder and a smartphone is able to be engaged on the other arm of the holder.

While these devices are adequate for the purpose for which they were designed, they are unsightly, rather bulky, and are not an object that the average woman would want sitting on their dresser or in their bathroom at times when they are not shooting selfies or videos.

### SUMMARY

The present disclosure is directed to a double-sided makeup mirror that closely resembles a typical double-sided makeup mirror in many respects but also has features that are “hidden in plain view”. The mirror is sufficiently aesthetically pleasing to leave on a dresser or bathroom vanity at all times but is also able to support a smartphone in a variety of different positions and is therefore highly suitable for taking selfies or shooting videos. The mirror includes a light ring that may be adjusted to provide different levels of lighting. When mirror and the electronic device are enabled (i.e., activated), the mirror and electronic device are able to establish a connection with each other and communicate with each other. In other words, the mirror and electronic device are able to be paired with each other. In particular, the mirror and electronic device are able to pair wirelessly. Technology such as BLUETOOTH® is able to be used to pair the mirror and the electronic device. (BLUETOOTH® is a registered trademark of BLUETOOTH SIG, INC. of Kirkland, Wash., US.) The mirror further includes a user interface that enables the electronic device, such as a smartphone, to be paired to the mirror and after that has occurred the user interface may be utilized to control the electronic device.

In summary, the present disclosure is directed to a lighted makeup mirror including a bar that forms part of a frame circumscribing and supporting a mirror assembly that has opposed mirror panels of different magnifications. A clamping device is engaged with the bar and is selectively movable therealong. The clamping device temporarily secures an electronic device, such as a smartphone, to the mirror. The mirror has a processor including programming which allows the mirror to be paired to the electronic device. A user interface on the mirror is actuated to allow a user to control the functions of the mirror and of electronic device. The user manipulates the user interface to shoot selfies or videos with the electronic device while illuminating their face with the mirror. The electronic device is movable and tiltable relative to the mirror so that the user is able to obtain a desired shot of them applying makeup or styling their hair. Because of the position of the slider rod, the electronic device will deliver a view of the user that is substantially similar to the image that the user will see reflected in one of the mirror panels (absent the magnification). As a consequence, the selfie or the video shot with the electronic device will feel more intimate and personal than was possible with previously known systems.

In one aspect, an exemplary embodiment of the present disclosure may provide a makeup mirror comprising a mirror assembly including a mirror; and a retaining assembly operatively engaged with the mirror assembly in such a way that the retaining assembly is movable relative to the mirror, and wherein said retaining assembly is adapted to hold an electronic device. In one embodiment, the makeup mirror includes a bar extending outwardly from the mirror assembly; wherein the retaining assembly is operatively engaged with the bar and is selectively movable between a first position and a second position relative to the bar. In one embodiment, the bar is spaced a distance outwardly from an outer surface of the mirror assembly and the bar circumscribes at least a portion of the outer surface of the mirror assembly. In one embodiment, the makeup mirror further comprises a locking mechanism selectively movable between a locked position and an unlocked position, wherein when the locking mechanism is in the locked position, motion of the retaining assembly relative to the mirror is substantially prevented, and wherein when the locking mechanism is in the unlocked position, the retaining assembly is movable relative to the mirror in one of a first direction and a second direction. In one embodiment, the makeup mirror further comprises a support assembly adapted to contact a surface; and the mirror assembly is operatively engaged with the support assembly and is retained by the support assembly a distance away from the surface.

In one embodiment, the retaining assembly includes a clamping device. In one embodiment, the retaining assembly includes a clamping device which comprises a housing operatively engaged with the that is operatively engaged with the mirror assembly; a ball arm assembly operatively engaged at a first end with the housing; wherein the ball arm assembly is rotatable relative to housing; and a holder body operatively engaged with a second end of the ball arm assembly; and wherein the holder body is rotatable relative to the ball arm assembly.

In one embodiment, the makeup mirror further comprises: a processor; programming provided in the processor, said programming being adapted to enable pairing of the makeup mirror with the electronic device retained by retaining assembly; and a user interface operatively engaged with the processor, wherein the user interface is actuated to enable control of the electronic device and of the mirror.

In one embodiment, the makeup mirror further comprises a light source provided on the mirror assembly, said light source being operatively engaged with the processor, and being operatively controlled via the user interface.

In another aspect, an exemplary embodiment of the present disclosure may provide in combination an electronic device; and a makeup mirror, wherein said makeup mirror includes a mirror assembly including a mirror; and a retaining assembly engaged with the mirror assembly and being selectively movable relative thereto, said retaining assembly being configured to temporarily secure the electronic device to the mirror assembly. In one embodiment, the combination further includes a bar operatively engaged with the mirror assembly, wherein the retaining assembly is engaged with the bar and is movable relative to the bar and thereby relative to the mirror assembly. In one embodiment, the combination further includes a processor; programming provided within the processor and being operable to control one or more functions of the electronic device and one of more functions of the mirror assembly; and a user interface operatively engaged with the processor; wherein the user interface is operable to control the one or more functions of the electronic device and the one or more functions of the mirror assembly.

In one embodiment, the clamping device may move circularly around a center point of the mirror assembly. In one embodiment the electronic device may move substantially parallel to a perimeter surface of the mirror assembly. In one embodiment the clamping device may include at least one ball joint; and the at least one ball joint may enable the electronic device to be rotated relative to the bar.

In another aspect, and exemplary embodiment of the present disclosure may provide a method of taking a selfie or shooting a video with an electronic device, said method comprising providing a makeup mirror including a mirror assembly that has a mirror; providing a bar on the mirror assembly a distance outwardly from the mirror; providing a retaining assembly on the bar; and temporarily securing an electronic device with the retaining assembly. In one embodiment, the method may further comprise circumscribing at least a portion of the mirror assembly with the bar. In one embodiment, the method may further comprise moving the retaining assembly relative to the bar from a first position to a second position. In one embodiment, the moving of the retaining assembly relative to the bar may be preceded by disengaging a locking mechanism. In one embodiment, the method may further comprise providing a support assembly on the makeup mirror, wherein the support assembly extends outwardly from the mirror assembly; and standing a base of the support assembly on a flat surface. In one embodiment, the method may further comprise pairing a processor on the makeup mirror with the electronic device; activating the electronic device using a user interface provided on the mirror assembly; and shooting a selfie or a video with a camera provided on the electronic device once the electronic device is activated. In one embodiment, the method may further comprise activating and controlling a light array provided on the mirror using the user interface.

In another aspect, the present disclosure may provide a method of taking a selfie or of shooting a video with an electronic device, said method comprising temporarily securing an electronic device in a clamping device provided on a makeup mirror; pairing a processor on the makeup mirror with the electronic device; providing a bar that is spaced a distance outwardly away from an outer perimeter of a mirror assembly of the makeup mirror; engaging the clamping device with the bar; moving the clamping device relative to the bar from a first position to a second position; activating the electronic device using a user interface provided on the mirror; and shooting a selfie or a video with a camera provided on the electronic device once the electronic device is activated. The method may further include activating a light array provided on the mirror using the user interface. The method may further comprise adjusting a level of light emitted by the light array using the user interface. The method may further include playing and/or pausing the electronic device using the user interface. The method may further include adjusting a level of sound recorded by or played by the electronic device using the user interface.

The moving of the clamping device relative to the bar may be preceded by disengaging a locking mechanism on the clamping device and may be followed by re-engaging the locking mechanism. The moving of the clamping device relative to the bar includes passing the clamping device over an upper region and/or a side region of the mirror assembly. The method may further include adjusting an angle of tilt of the electronic device relative to a housing of the clamping device. The adjusting may further include moving the electronic device utilizing at least one ball joint provided on the clamping device.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a top, front, perspective view of a makeup mirror in accordance with an aspect of the present disclosure, with the mirror being shown with a first embodiment of a clamping device for engaging an electronic device;

FIG. 2 is a top, rear, perspective view of the makeup mirror;

FIG. 3A is an exploded top, front, perspective view of the mirror assembly of the makeup mirror;

FIG. 3B is an exploded to, front perspective view of the support base assembly of the makeup mirror;

FIG. 3C is a horizontal cross-section of the second mounting hub and part of the mirror taken along line 3C-3C of FIG. 1;

FIG. 3D is a vertical cross-section of the second mounting hub and part of the mirror taken along line 3D-3D of FIG. 1

FIG. 4 is an exploded top, front, perspective view of the clamping device shown on its own;

FIG. 4A is top plan view of the lower housing section of the housing showing the slider brakes in a locked position;

FIG. 4B is a top plan view of the lower housing section of the housing showing the slider brakes in an unlocked position;

FIG. 5 is a top plan view of the makeup mirror;

FIG. 5A is a front elevation view of the holder body shown in an unexpanded position;

FIG. 5B is a front elevation view of the holder body shown in an expanded position;

FIG. 6 is a front elevation view of the makeup mirror showing an electronic device engaged with the clamping device and showing the electronic device in three possible different orientations relative to the mirror; and

FIG. 7 is a top, front, perspective view of the makeup mirror of FIG. 1 showing a second embodiment of a clamping device for engaging the electronic device.

Similar numbers refer to similar parts throughout the drawings.

### DETAILED DESCRIPTION

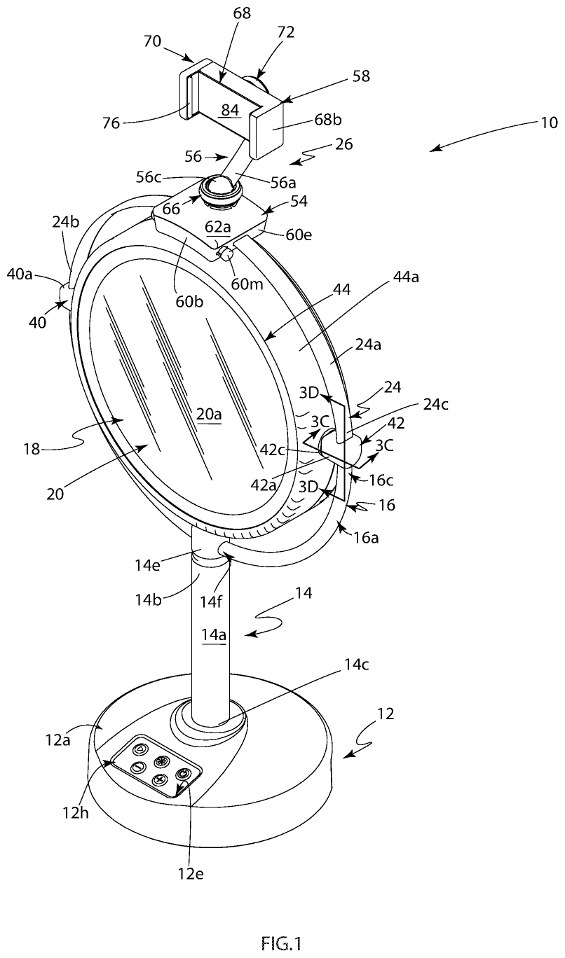

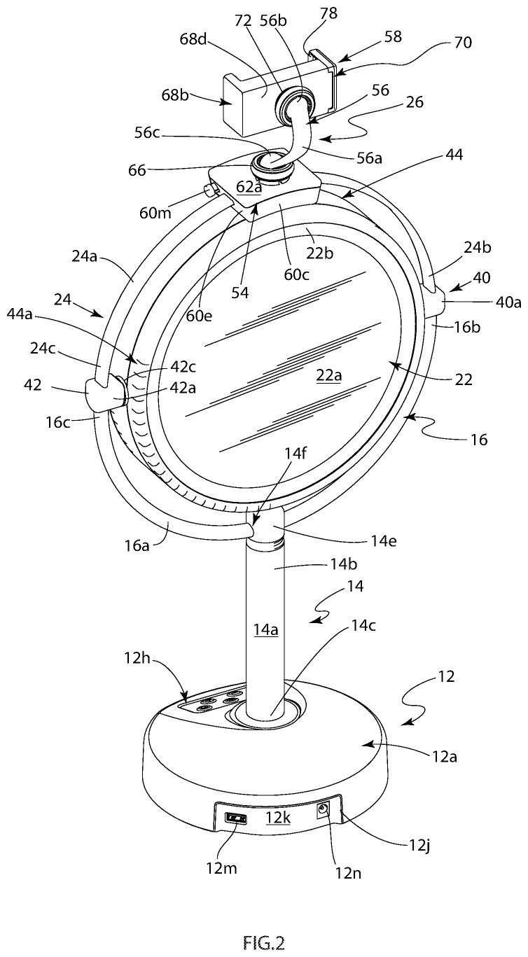

FIGS. 1-5 show a makeup mirror in accordance with the present disclosure, generally indicated at 10. Makeup mirror 10 (hereafter “mirror 10”) includes a support assembly that is configured to hold a mirror assembly. The support assembly includes a base 12, a support including a support shaft 14 and a support bar 16. The mirror assembly 18 includes, amongst other components, a first mirror panel 20 and a second mirror panel 22 (FIG. 2). Many of the features of base 12, support shaft 14, support bar 16, and the mirror assembly 18 may be found in a number of previously known makeup mirrors. Mirror 10 differs from previously known makeup mirrors in that it also includes, in addition to other different components, a bar 24 and a retaining assembly 26, the purpose of which will be described herein. All of these component parts and the differences between prior art makeup mirrors and mirror 10 in accordance with the present disclosure will be described in greater detail hereafter.

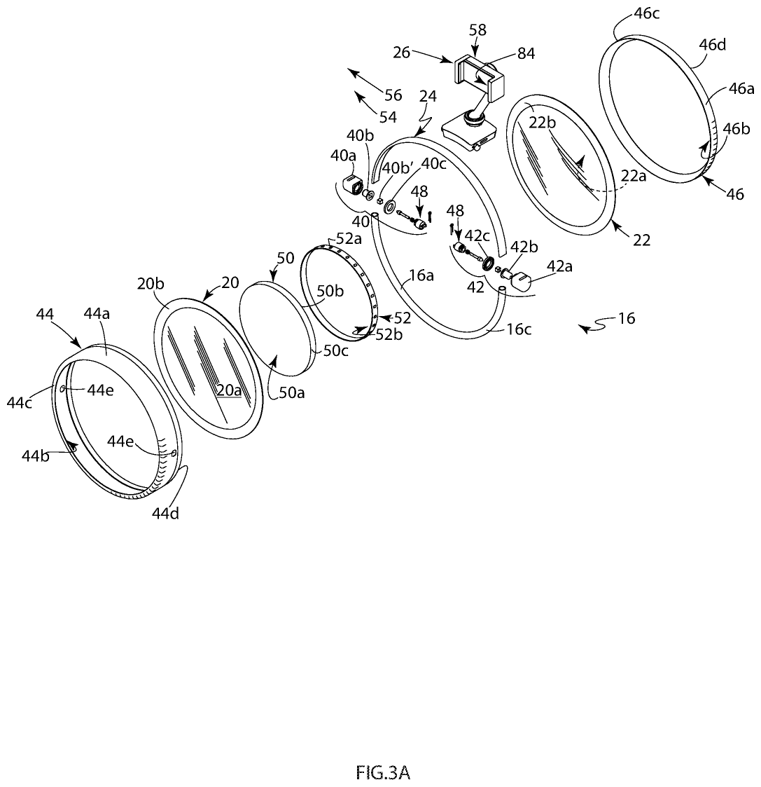

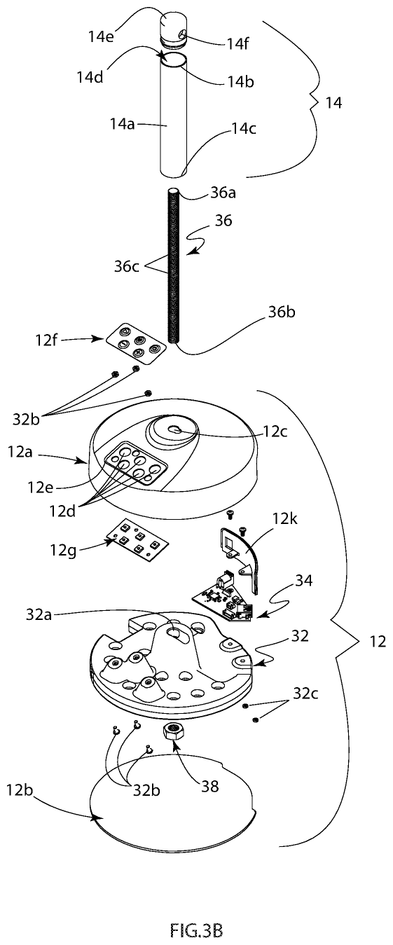

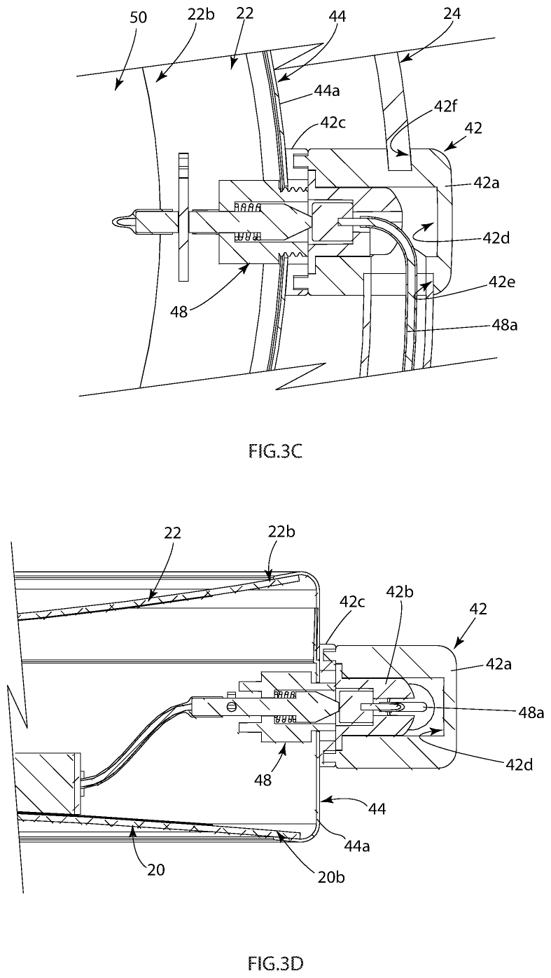

Support assembly is shown in detail in FIGS. 1-3A. Mirror assembly 18 is shown in detail in FIGS. 1, 2, 3B, 3C, and 3D. Base 12 includes an upper housing 12a and a lower housing 12b (FIG. 3A) that are complementary and configured to interlocking engage each other. Upper and lower housing 12a, 12b together bound and define an interior cavity (not shown) that houses a number of components. A lower surface of lower housing 12b is designed to rest in abutting contact with a flat surface such as an upper surface of a bathroom vanity or a dresser. The lower surface of lower housing 12b may be provided with any suitable type of non-slip finish, i.e., a friction-increasing surface. One suitable non-slip or friction-increasing surface may be a rubber pad, for example.

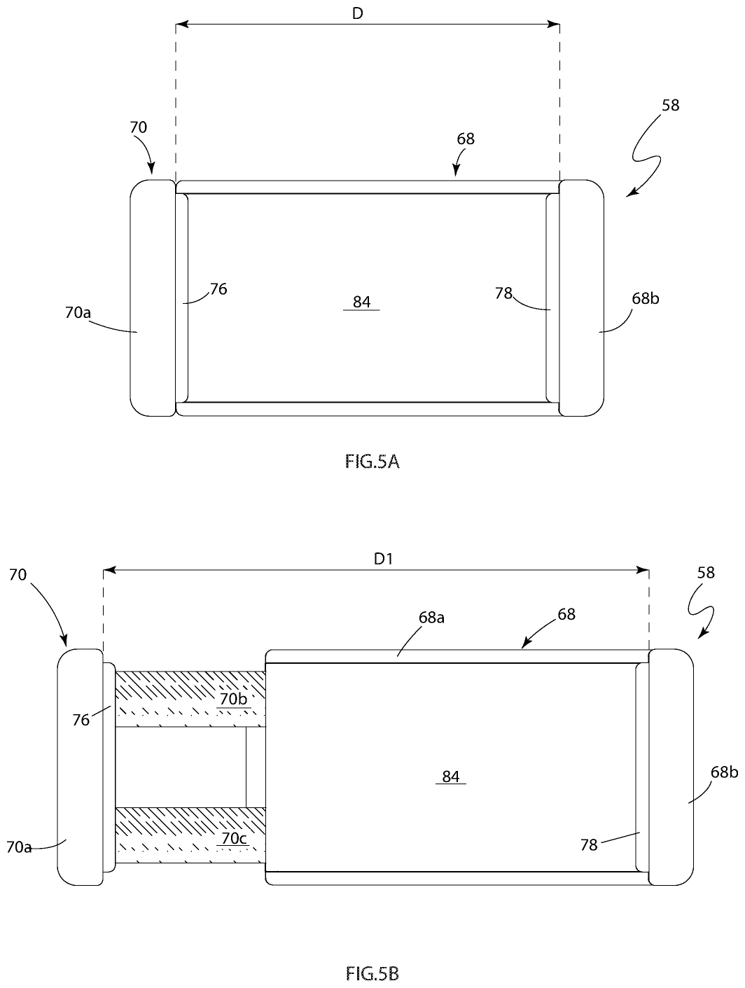

Upper housing 12a is provided with a user interface that is actuated to control various functions of the mirror 10. For example, the user interface is operatively engaged with the light array 52 and is able to switch the light array 52 on or off, and may be used to control the intensity or brightness of the light provided by light array 52. The user interface is also able to be used to control an electronic device that is operatively engaged with mirror 10 and is wirelessly paired therewith. The user interface may take any of a variety of different forms. As illustrated in the attached figures, the user interface is in the form of a tactile control panel. In particular, the figures show that upper housing 12a includes an upper wall with a centrally-located aperture 12c (FIG. 3A) and a plurality of secondary apertures 12d that are arranged in a recessed region 12e located toward a front of the upper housing 12a. Each aperture 12c, 12d extends from an outer surface of the upper housing 12a to an interior surface thereof. A button membrane 12f is positionable over recessed region 12e that includes secondary apertures 12d. A button printed circuited board (PCB) 12g is supported within the interior cavity of base 12 in a position immediately beneath recessed region 12e and such that the controls on button PCB may be contacted by a user contacting specified regions on button membrane 12f. Together, button PCB 12g and button membrane 12f form the control panel 12h (FIGS. 1 and 5), i.e., the user interface that enables control of mirror 10 and the associated electronic device.

It will be understood that instead of the illustrated control panel 12h, in one embodiment the user interface provided on mirror 10 may be a touchscreen. In other embodiments, the control panel 12h may be replaced with a voice activated system.

Control panel 12h, as illustrated includes a play/pause button 28 (FIG. 5), a lighting brightness button 30, a power button 29 (i.e., a button for switching mirror 10 “on” or “off”), a volume down/shutter button 31, and a volume up/shutter button 33. It will be understood that the particular buttons provided on mirror may be arranged in any desired configuration or pattern. Fewer or more control buttons may be provided instead of the aforementioned buttons 28, 29, 30, 31, and 33. Various operational features of mirror 10 are activated or deactivated by engaging control panel 12h, as will be described later herein.

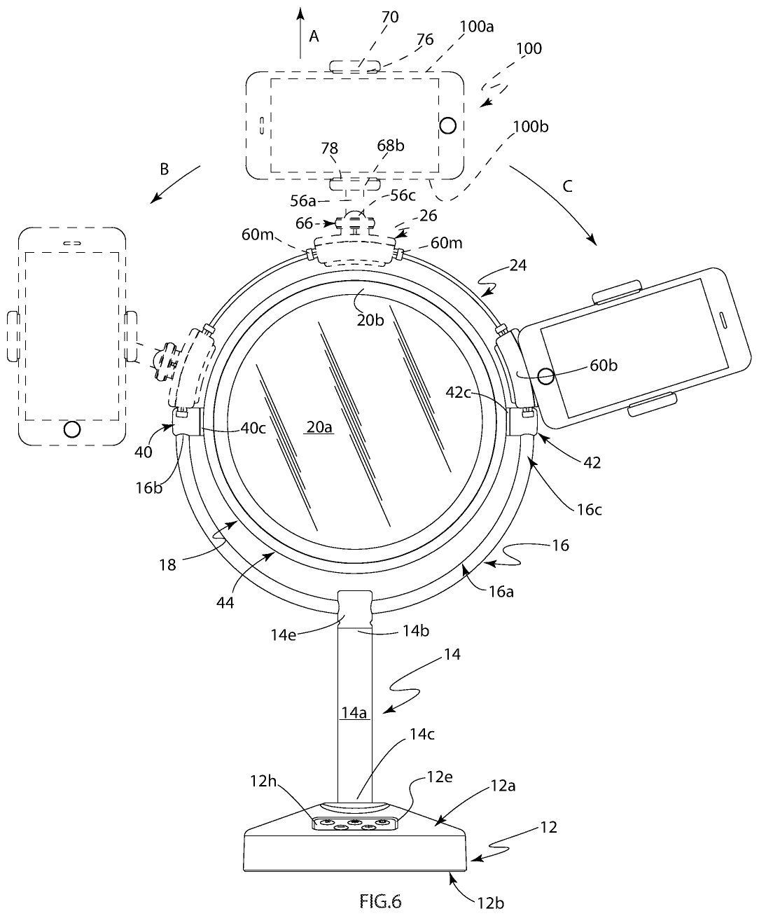

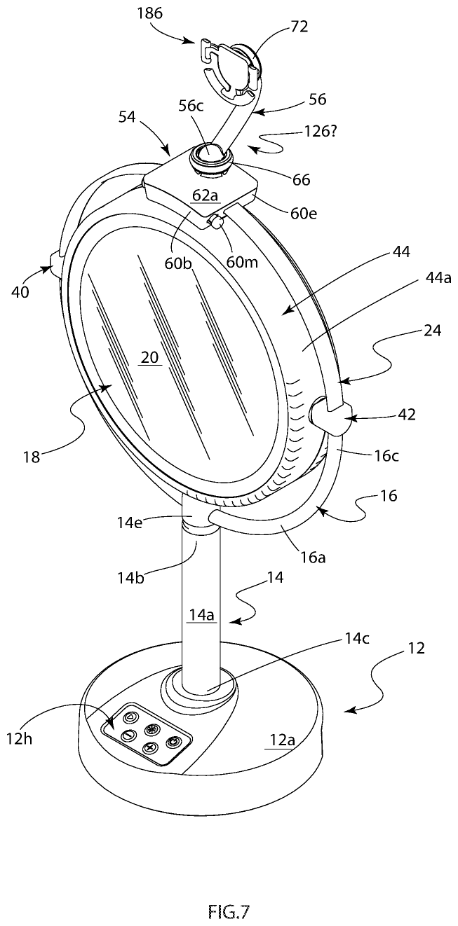

Base 12a also includes a weight 32 (FIG. 3A) that is received within the interior cavity defined by upper housing 12a and lower housing 12b. Weight 32 may be contoured to act as a platform for mounting of the button PCB 12g and another PCB 34. PCB 34 may be the primary PCB for mirror 10. PCB 34 includes a processor (not specifically identified by number in FIG. 3A) that is provided with programming for controlling the operation of mirror 10 and for controlling at least some of the functions of an electronic device 100 (FIG. 6) that is paired with mirror 10. Weight 32 may also include a plurality of apertures and through-holes through which fasteners are utilized to secure components line button PCB 12g and PCB 34 to weight 32. One of these plurality of apertures and through-holes is a centrally-located, vertically-oriented slot 32a that extends vertically through weight 32 from a top surface thereof to a bottom surface thereof. Weight 32 helps to ensure that the center of gravity of mirror 10 is as low to a surface upon which mirror rests as possible. Weight 32 helps to provide resistance to mirror 10 being easily slide along the surface upon which it rests and further aids in preventing mirror 10 from being inadvertently knocked over.

As best seen in FIG. 3A, support shaft 14 includes a tubular wall 14a that has a first end 14b and a second end 14c. Wall 14a bounds and defines an interior bore 14d that extends from an opening in first end 14b to an opening in second end 14c. Second end 14c of support shaft 14 is placed on upper housing 12a such that bore 14d in support shaft 14 is vertically aligned with central aperture 12c and slot 32a in weight 32 within the interior cavity of base 12.

A threaded rod 36 (FIG. 3A) is provided to connect base 12 and support shaft 14 together. Rod 36 is a tubular member that has an upper end 36a and a lower end 36b. A plurality of threads 36c are provided on an outer surface of the tubular member. Rod 32 is received into the inserted into slot 32a in weight 32 in such a way that the lower end 36b of rod 36 passes through weight 32 to beneath a lower end of the weight. The lower end 36b of rod 36 is secured in place by a threaded nut 38 engaging threads 36c. An upper end 36b of rod 36 passes through central aperture 12c in upper housing 12a and is received into bore 14d of shaft 14. A shaft hub 14e is provided for engagement with upper end 14b of support shaft 14. A lower end of shaft hub 14e is of reduced diameter and is configured to be received within the opening to bore 14d of support shaft 14. Although not shown in the attached figures, it will be understood that the lower end of shaft hub 14e defines an interiorly-threaded recess that is vertically alignable with central aperture 12c of base 12. Shaft hub 14e is threadedly engaged with the threads 36c on top end 36a of rod 36. When shaft hub 14e is engaged with support shaft 14 and rod 36, a peripheral side wall of the shaft hub 14e is substantially flush with the peripheral side wall of the rest of support shaft 14. Shaft hub 14e defines a through-hole 14f therein that extends from a first side of shaft hub 14e to a second side thereof and runs generally transversely through shaft hub 14e, i.e., generally parallel to a front of mirror 10. The purpose of hole 14f will be discussed later herein. Weight 32 and upper housing 12a are secured to shaft 14 by way of nut 38 and shaft hub 14e. A best seen in FIG. 3A, button PCB 12g and PCB 34 are secured to weight by fasteners 32b, 32c, respectively.

Referring now to FIG. 2, a notch 12j is defined in a rear region of upper housing 12a. A back plate 12k is secured to upper housing 12a to close off notch 12j. Back plate 12k may include one or more electrical connectors for operatively engaging various types of electrical cables and therefore electronic devices, to appropriate ports on PCB 34. As illustrated, back plate 12k includes a Universal Serial Bus (USB) port 12m for connecting an electronic device such as a smartphone to mirror 10. Back plate 12k further includes a power port 12n that is configured to receive a power cable to connect mirror 10 to a power supply such as a wall outlet. It will be understood, however, that any other type of electrical connectors may be provided on back plate 12k instead of or in addition to USB port 12m and power port 12n. Additionally, it should be understood that the particular arrangement of the electrical connectors 12m, 12n relative to each other will be dictated by the configuration of the PCB 34.

Although not illustrated herein, it should be understood that mirror 10 may, in some embodiments, be provided with an internal power source such as one or more batteries that may be housed within an appropriate battery mounting within interior cavity of base 12. If this is the case, then an additional notch and cover plate may be provided to enable a user to access the battery mounting.

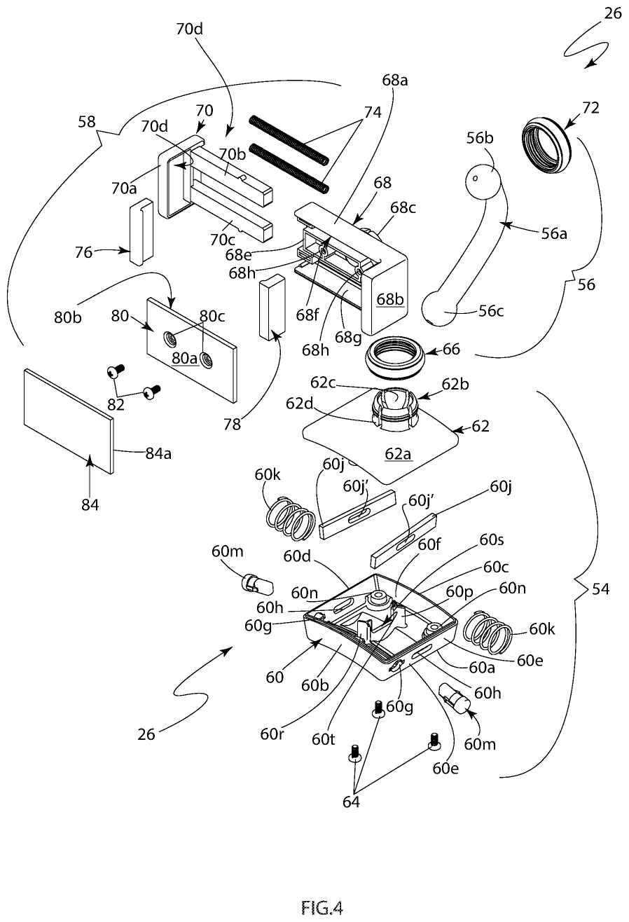

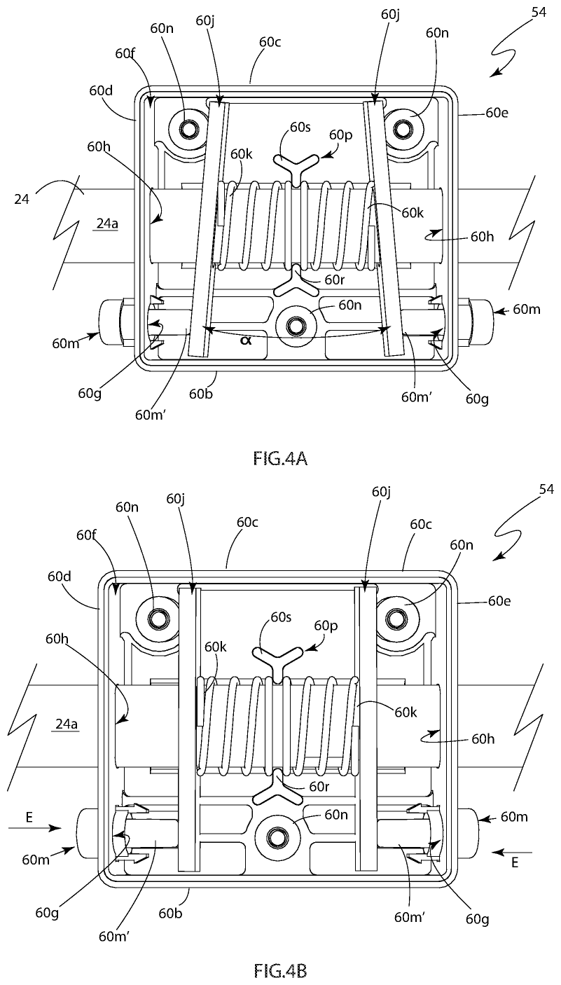

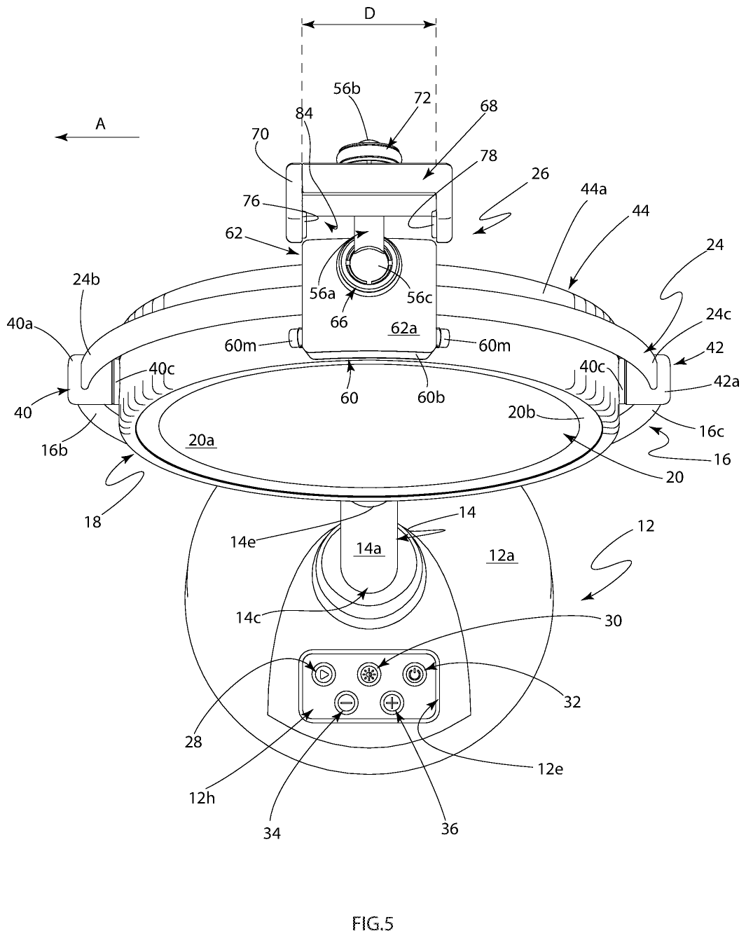

It should be understood that FIGS. 3 and 4 do not show any wiring between button PCB 12g, control panel 12h, PCB 34, and any of the electronic components provided on mirror 10 (as will be described later herein). The wiring has simply been omitted from the various figures for clarity of illustration. It should be understood, however, that any necessary wiring will be provided within mirror 10 to operatively engage the various electrical components of mirror 10 to each other as necessary.

PCB 34 is provided with appropriate components and logic to enable wireless connection between PCB 34 and any electronic device that may be engaged with mirror 10. One such electronic device, a smartphone, is shown in FIG. 6, generally indicated by the reference number 100. It will be understood that PCB 34 may enable mirror 10 to be wirelessly engaged with other remote electronic devices that are not necessarily engaged with mirror, should that be desirable.

FIGS. 1, 2, and 3, show support bar 16 engaged with support shaft 14.

Support bar 16, as illustrated, is a tubular member having a peripheral wall 16a with a first end 16b and a second end 16c. First end 16b and second end 16c are laterally or transversely spaced from each other. Wall 16a has an outer diameter that enables support bar 16 to pass through the hole 14f defined in support hub 14e. Support bar 16 may be of any desired configuration. As illustrated in the attached figures, wall 16a of support bar 16 is circular in cross-section but it will be understood that wall 16a may be of any desired cross-sectional shape, including square or rectangular. Support bar 16 is illustrated as being generally curved U-shaped, in particular a curved semi-circular shape, when mirror 10 is viewed from the front or back. It will be understood, however, that support bar 16 may take other desired configuration such as being generally V-shaped (with the apex engaged in support hub 14e). Additionally, instead of being gently curved, support bar 16 may be U-shaped but have sharp, ninety-degree corners.

As indicated above, support bar 16 has a first end 16b (FIG. 2) and a second end 16c that are laterally spaced a distance from each other. First end 16b and second end 16c are also illustrated as being generally horizontally aligned with each other such that a distance between support hub 14e and first end 16b is substantially of the same length as the distance between support hub 14e and second end 16c. It will be understood that in other embodiments, which are not illustrated herein, the distance between support hub 14e and first end 16b and the distance between support hub and second end 16c may be different in length.

Mirror assembly 18 is engaged with support bar 16 utilizing a first mounting hub 40 and a second mounting hub 42. First mounting hub 40 is engaged with first end 16b of support bar 16 and second mounting hub 42 is engaged with second end 16c of support bar 16. First mounting hub 40 and second mounting hub 42 are substantially identical to each other in structure and function but are arranged in mirror 10 as mirror images of each other. The structure and function of first and second mounting hubs 40, 42 will be described in greater detail below.

Referring to FIGS. 3B, 3C and 3D, mirror assembly 18 includes a front mirror housing 44 and a rear mirror housing 46 that are configured to be complementary to each other and to be operatively engageable with each other. Front mirror housing 44 and rear mirror housing 46 are illustrated as being generally circular in shape when viewed from the front or back. It will be understood, however, that the mirror housings 44, 46 may be of any desired shape. If the mirror housings 44, 46 are configured as being generally square, rectangular, or another other desired shape, the support bar 16 may be fabricated in a shape that is substantially complementary to the shape of the mirror housings, e.g. shaped in a similar fashion to an outer surface of a lower region and parts of the sides of the mirror housings. Alternatively, the general shape of the mirror housings and support bar may be different; e.g., the mirror housings may be generally circular but the support bar may be triangular or in the shape of a triangle, or vice versa.

Front mirror housing 44 comprises a substantially annular ring 44a that bounds and defines a central aperture 44b. Ring 44a is substantially circular in configuration and extends from a first edge 44c to a second edge 44d. A pair of through-holes 44e are defined in ring 44a with the holes 44e extending from an outer surface of the ring 44a to an interior surface thereof. Holes 44e are shaped, sized, and positioned to each receive a light power connector 48 therethrough. Each light power connector 48 is supported by one of the first and second mounting hubs 40, 42.

First mounting hub 40 includes a hub shell 40a, hub internals 40b, and a mounting washer 40c. Second mounting hub 42 also includes a hub shell 42a, hub internals 42b, and mounting washer 42c. First and second mounting hubs 40, 42 are substantially identical to each other and are substantially identical to previously known mounting hubs for PRIOR ART makeup mirrors except for various features that will be specifically pointed out hereafter. As a consequence, many of the components provided in first and second mounting hubs 40, 42 are known and will not be discussed in any particular detail herein. FIGS. 3C and 3D, show a horizontal cross-section and a vertical cross-section, respectively, through second mounting hub 42. The various hub internals 42a are provided at least partially within a cavity 42d defined by hub shell 42a and extend outwardly therefrom through an aperture defined in washer 42c, through aperture 44e defined in annular ring 44a, and into engagement with light power connector 48. Washer 42c may be fixedly secured to annular ring 44a. Hub shell 42a has an upper surface and a lower surface which are opposed to each other. Lower surface defines a first aperture 42e that is shaped and sized to receive the second end 16c of support bar 16 therein. Second end 16c of support bar 16 is fixedly engaged with hub shell 42a by any suitable means, such as being glued or welded thereto. Lighting power connector 48 is operatively engaged with wiring 48a that extends upwardly through a bore defined in support bar 16 and into cavity 42d and into engagement with hub internals 42b. Lighting power connector 48 is also operatively engaged with a light array 52 (FIG. 3D) provided on mirror assembly 18. Light array 52 will be described later herein.

Second mounting hub 42 differs from previously known mounting hubs in that the upper surface of hub shell 42a defines a second aperture 42f therein that is shaped and sized to receive the second end 24c of bar 24 therein. The second end 24c of bar 24 is fixedly secured to hub shell 42a by any suitable means, such as by being glued or welded thereto.

Rear mirror housing 46 is a substantially annular ring 46a that bounds and defines a central aperture 46b. The ring 46a is substantially circular in configuration and extends from a first edge 46c to a second edge 46d. The outer diameter of ring 46a is slightly smaller than the inner diameter of ring 44a and ring 46a is configured to be received within the aperture 44b defined by ring 44a. The width of ring 46a, measured from first edge 46c to second edge 46d, is less than the width of ring 44a, measured from first edge 44c to second edge 44d. When ring 46a is snap-fittingly engaged within ring 44a, first edge 46a of ring 46 is positioned rearwardly of holes 44e so that light power connectors 48 are able to extend through holes 44e and into the central aperture 44b defined by ring 44a.

Mirror assembly 18 further includes a core member 50. Core member 50 may be comprised of a rigid foam or any other suitable supportive material. Core member 50 may be a substantially solid disk that has a front surface 50a and an opposed rear surface 50b, and a perimeter wall 50c.

Mirror assembly 18 further includes a light source for illuminating the face of a user looking into mirror assembly 18. That light source takes the form of a light array 52 that is provided on mirror assembly 18. Light array 52 comprises an annular ring 52a which bounds and defines a central aperture 52b. Annular ring 52a includes one or more Light Emitting Diodes (LEDs). Ring 52a is of a complementary shape to perimeter wall 50c of core member 50. Perimeter wall 50c and ring 52a of light array 52 are illustrated herein as being circular but any other different shape may be utilized for these components; the shape being complementary to the overall shape of mirror assembly 18. The interior diameter of ring 52a is such that core member 50 may be received therein. In one embodiment, the perimeter wall 50c of core member 50 abuts the inner surface of ring 52a.

Referring still to FIGS. 3B, 3C and 3D, mirror assembly 18 further includes first mirror panel 20 and second mirror panel 22 which are generally identical in construction and function. The two mirror panels 20, 22 are arranged as mirror images of each other about core member 50, with a rear surface of first mirror panel 20 abutting front surface 50a of core member 50 and a front surface of second mirror panel 22 abutting rear surface 50b of core member 50. First mirror panel 20 includes a central reflective area 20a that is bounded by a transparent, translucent, or opaque area 20b. As illustrated, central reflective area 20a is generally circular in shape and is circumscribed by the transparent, translucent, or opaque area 20b. Similarly, second mirror panel 22 includes a central reflective area 22a (FIG. 2) that is circumscribed by a transparent, translucent, or opaque area 22b. First mirror panel 20 and second mirror panel 22 may differ from each other in the degree of magnification that their reflective areas 20a, 22a provide.

When mirror assembly 18 is assembled, the interior surfaces of the reflective areas 20a, 22a of first mirror panel 20 and second mirror panel 22 are positioned in contact with the front surface 50a and rear surface 50b of core member 50, respectively. Light array 52 is generally aligned with the transparent, translucent, or opaque areas 20b, 22b of first mirror panel 20 and second mirror panel 22. Consequently, when light array 52 is activated, a halo of light will shine outwardly from the light array 52 through one or both of the transparent, translucent, or opaque areas 20b, 22b. (It will be understood that substantially no light will shine through the reflective areas 20a, 22a.) The functioning of mirror will be further described later herein.

In accordance with an aspect of the present disclosure, mirror 10 further includes bar 24. Bar 24 includes a wall 24a that comprises a thin strip of material that extends from first mounting hub 40 to second mounting hub 42 over a top region of mirror assembly 18. Together, bar 24 and support bar 16 circumscribe the circumferential outer surface of the ring 44a of front mirror housing 44. Bar 24 is illustrated as being a generally inverted U-shape when mirror 10 is viewed from the front or from the back. Wall 24a of bar 24 is illustrated as being generally rectangular in cross-section but it will be understood that other overall shapes and other cross-sectional shapes for bar 24 may be utilized instead of the U-shape and rectangular shape illustrated herein.

Wall 24a of bar 24 has a first end 24b and a second end 24c. First end 24b is configured to be engaged with first mounting hub 40 and second end 24c is configured to be engaged with second mounting hub 42. When mirror 10 is viewed from the front or back, bar 24 together with support bar 16 circumscribes a portion of the circumferential outer surface of ring 44a of mirror assembly 18. In accordance with another aspect of the present disclosure, a retaining assembly 26 is operatively engaged with bar 24. Retaining assembly 26 is able to move relative to bar 24 from a first position proximate first end 24b and first mounting hub 40 through to a second position proximate second end 24c and second mounting hub 42. Retaining assembly 26 is additionally able to be positioned anywhere along the arc of bar 24, with the specific position being selected by a user.

Referring mainly to FIGS. 1 and 4, the various component parts of retaining assembly 26 are illustrated. Retaining assembly 26 includes a housing 54, a ball arm assembly 56, and a clamping device 58. Clamping device 58 is configured to clampingly engage an electronic device 100 therein as is illustrated in FIG. 6. The housing 54 and bar 24 enable the clamping device 58 to be operatively engaged with the mirror assembly 18. The bar 24 enables clamping device 58 to move relative to the mirror 20/22. The ball arm assembly 56 enables the clamping device to pivot relative to the mirror 20/22.

Housing 54 includes a lower housing section 60 and an upper housing section 62 that are complementary configured and designed to operatively engage each other. Lower housing section 60 includes a bottom wall 60a, a front wall 60b, a back wall 60c, a first side wall 60d, and a second side wall 60e. Bottom wall 60a, front wall 60b, back wall 60c, first side wall 60d, and second side wall 60e bound and define a receptacle 60f. Front wall 60b is opposed to back wall 60c. First side wall 60d is opposed to second side wall 60e. First and second side walls 60d, 60e each define an aperture 60g and a longitudinally extending slot 60h therein. Apertures 60g and slots 60h each extend from an outer surface of the associated side wall 60d, 60e to an interior surface thereof. Apertures 60g are laterally aligned with each other. Similarly, slots 60h are laterally aligned with each other. Apertures 60g and slots 60h are in fluid communication with receptacle 60f. Slots 60h are complementary in shape and size to the cross-sectional shape of bar 24. Housing 54 is engaged with bar 24 by passing first end 24b or second end 24c of bar 24 through one of the slots 60h defined in the lower housing section 60, through the receptacle 60f and out of the other of the slots 60h. Housing 54 is engaged with bar 24 prior to securing the respective first end 24b or second end 24c of the bar to the respective one of the first and second mounting hubs 40, 42.

The motion of the housing 54 along bar 24 will be discussed later herein. Lower housing section 60 and thereby housing 54 would be able to freely slide along bar 24 except that mirror 10 further includes a locking mechanism provided on the housing 54. The locking mechanism is selectively movable between a locked position and an unlocked position. When the locking mechanism is in the locked position, motion of the retaining assembly relative to the mirror is prevented. When the locking mechanism is moved to the unlocked position, motion of the retaining assembly relative to the mirror is possible. In particular, when the locking mechanism is in the locked position, the housing 54 (and thereby the clamping device 58 and electronic device 100 if engaged therewith) relative to the bar 24 is substantially prevented. When the locking mechanism is in the unlocked position, the housing 54 (and thereby the clamping device 58 and electronic device 100 if engaged therewith) is movable relative to the bar 54.

One suitable locking mechanism is illustrated in FIGS. 4, 4A and 4B, and includes one or more slider brakes 60j, one or more slider springs 60k, one or more slider buttons 60m, and a cradle 60p. Slider brakes 60j are positioned within receptacle 60f of lower housing section 60 and are operative to selectively engage bar 24 to prevent movement of lower housing section 60 therealong. Slider springs 60k and cradle 60p are provided within receptacle 60f of housing 54. Each slider button 60m is located partially within receptacle 60f and extends partially outwardly from housing 54.

Each slider brake 60j is a generally rectangular strip having a rear end (unnumbered), a front end (unnumbered), and defines a longitudinally-extending slot 60j′ therein. Each slot 60j′ extends from a first side of the associated slider brake 60j to a second side thereof. Lower housing section 60 includes a plurality of vertically-oriented bosses 60n (FIG. 4), each of which defines a vertically-oriented bore therethrough. The slider brakes 60j are laterally spaced apart from each other and are oriented such that the rear end of each slider brake 60j is located adjacent back wall 60c of housing 54 and interiorly positioned adjacent one of the bosses 60n. Slider brakes 60j extend forwardly toward front wall 60b of housing 54. A front end of each slider brake 60j is located a distance laterally outwardly from the boss 60n that is centrally-located proximate front wall 60b. Springs 60k are positioned around a portion of bar 24 that is located between the two slider brakes 60j and an end of each spring 60k contacts the interior side wall of one of the slider brakes 60j.

Cradle 60p extends upwardly from an interior surface of bottom wall 60a of lower housing section 60. Cradle 60p is oriented generally perpendicular to front wall 60b and rear wall 60c of lower housing section 60 and is generally U-shaped when viewed from either of the first side or second side of lower housing section 60. Cradle 60p has a first end 60r and a second end 60s spaced longitudinally apart. An upper surface of cradle 60p defines a U-shaped recess 60t (FIG. 4) therein that extends between a first side and a second side of the cradle 60p. Recess 60t is of a length that is slightly wider than the width of bar 24 and a portion of bar 24 is received within recess 60t as is shown in FIGS. 4A and 4B. A lower region of recess 60t is located at a height from bottom wall 60a that is substantially horizontally aligned with slots 60h defined in side walls 60d, 60e of lower housing section 60. Each of the first end 60r and second end 60s of cradle 60p has an upper surface configured into a Y-shape (FIGS. 4A and 4B). Each Y-shape has a shaft 60r′, 60s′ terminating adjacent recess 60t. When the portion of the bar 24 is received in recess 60t, the terminal ends of shafts 60r′, 60s′ are located proximate the side edges of bar 24 and thus keep bar 24p engaged within cradle 60p. The springs 60k are located on either side of cradle 60p. The portion of bar 24 thus passes through slot 60h defined in side wall 60d of lower housing section 60, through slot 60j′ of a first slider brake 60j, through recess 60t, through slot 60j′ of the second slider brake 60j, and then through slot 60h defined in side wall 60e of lower housing section 60.

Each slider button 60m has a first end 60m′ that is received through one of the holes 60g in side walls 60d, 60e of lower housing section 60. The rest of each slider button 60m extends outwardly from the associated hole 60g and projects for a distance beyond the associated side wall 60d, 60e.

As indicated above, lower housing section 60 further includes a plurality of vertically-oriented bosses 60n (FIG. 4), each of which defines a vertically-oriented bore therethrough. The bore is not numbered in FIG. 4. Fasteners 64 are inserted through the bore of each boss 60n from the underside of lower housing section 60 and into aligned bores of bosses provided on a lower surface of upper housing section 62. The fasteners 64 are utilized to secure upper housing section 62 to lower housing section 60.

Referring still to FIG. 4, upper housing section 62 includes an upper surface 62a from which a socket member 62b extends upwardly. Socket member 62b that includes a hemispherical cup 62c. A plurality of threads 62d is provided around an outer surface of the socket member 62b. Socket member 62b is provided for engagement of a first end of ball arm assembly 56.

Ball arm assembly 56 includes a curved shaft 56a with a first ball 56b at a first end and a second ball 56c at a second end. Cup 62c of socket member 62a of upper housing section 62 is shaped and sized to receive second ball 56c therein. An internally threaded nut 66 is threadedly engaged with threads 62d of socket member 62b in order to secure second ball 56c within cup 62c.

First ball 56b is operatively engaged with clamping device 58 as will be described hereafter. FIGS. 2, 4, and 5 show clamping device 58 in greater detail. Clamping device 58 includes a slider body 68 and an extender body 70. Slider body 68, as illustrated, is an L-shaped member which includes a first leg 68a and a second leg 68b. First leg 68a is configured to extend transversely and substantially parallel to front wall 60b of lower housing section 60 when retaining assembly 26 is assembled. Second leg 68b extends outwardly and forwardly from one end of first leg 68a and is generally oriented at right angles to a front surface of first leg 66a. A rear surface 68c (FIG. 2) of first leg 68a includes a second socket member 68d (FIG. 4) configured to receive first ball 56b of ball arm assembly 56 therein. Second socket member 68d is substantially identical in structure and function to socket member 62b. Although not illustrated in the figures, second socket member 68d includes a hemispherical cup shaped and sized to receive first ball 56b of ball arm assembly 56 therein and further includes threads on the outer surface of the second socket member 68d. An interiorly threaded nut 72 is threadedly engaged with the threads on second socket member 68d to secure first ball 56b within the cup of second socket member 68d.

A central region 68e extends outwardly and forwardly from the front surface of first leg 68a. A first slot 68f is defined between an upper surface of central region 68e and a bottom surface of an upper region of first leg 68a. A second slot 68g is defined between a lower surface of central region 68e and an upper surface of a lower region of first leg 68a. First slot 68f and second slot 68g are vertically spaced apart from each other, extend transversely outwardly from second leg 68b, and are substantially parallel to each other. The purpose of slots 68f, 68g will be described hereafter. A pair of bosses 68h extend outwardly from central region 68e. Each boss 68h is generally parallel to second leg 68b and defines a bore (not numbered) therein.

FIG. 4 shows that clamping device 58 further includes an extender body 70. Extender body 70 is generally L-shaped when viewed from above and includes a side wall 70a, a first arm 70b, and a second arm 70c. First and second arms 70b, 70c are vertically aligned with each other and vertically spaced from each other. First and second arms 70b, 70c extend transversely outwardly from an inner surface of side wall 70a and generally at right angles relative thereto. When clamping device 58 is assembled, side wall 70a is opposed to second leg 68b of slider body 68 and first and second arms 70b, 70c are parallel to first leg 68a of slider body 68. First arm 70b is shaped, sized, and positioned to be received within first slot 68f on slider body 68. Second arm 70c is shaped, sized, and positioned to be received within second slot 68g of slider body 68.

Springs 74 are positioned between the free ends of each of the first arm 70b and second arm 70c and the inner surface of second arm 68b of slider body 68. Each spring 74 is secured at a first end to one of first arm 70b or second arm 70c, and is secured at a second end to the inner surface of second arm 68b of slider body 68. Springs 74 are coil springs that are expanded as side wall 70a is moved away from second arm 68b when a pulling force is applied to side wall 70a. When the pulling force is removed, coil springs 74 return towards their default non-expanded stated, and thereby move side wall 70a back towards second arm 68b. This will be further discussed later herein.

A first pad 76 is positioned in a recessed region 70d defined in side wall 70a of extender body 70. Similarly, a second pad 78 is positioned within a similar recessed region (not shown in FIG. 4) defined in the inner surface of second arm 68b of slider body 68. First and second pads 76, 78 preferably are fabricated from a resilient material. One suitable resilient material is foam. The purpose of pads 76, 78 will be described later herein.

A lock plate 80 is provided to help retain first and second arms 70b, 70c in engagement with slider body 68. Lock plate 80 has a front surface 80a and a rear surface 80b that is opposed to front surface 80a. A pair of laterally-spaced apertures 80c extend between front surface 80a and rear surface 80b. Fasteners 82 are inserted through apertures 80c and into the internally threaded bosses 68h defined in the central region 68e of first arm 68a. A front plate 84 is engaged with lock plate 80 in any suitable manner such as by having an adhesive applied between front surface 80a of lock plate 80 and a rear surface 84a of front plate 84.

Bar 24 together with support bar 16 is illustrated as being spaced a short distance outwardly away from the circumferential outer surface of ring 44a of mirror assembly 18. When mirror assembly 18 is arranged such that one or the other of the first and second mirror panels 20, 22 is facing a front of the mirror assembly 18, support bar 16 at least partially circumscribes a portion of the circumferential surface of the mirror assembly 18, i.e., support bar 16 at least partially circumscribes the circumferential outer surface of ring 44a. Additionally, bar 24 circumscribes substantially a rest of the circumferential outer surface of the mirror assembly 18, i.e., a rest of the circumferential outer surface of ring 44a. Support bar 16 and bar 24 are in the same plane and when mirror assembly 18 is viewed from the front and is aligned with support bar 16 and bar 24, support bar 16 and bar 24 together form a substantially circular member. Additionally, the shape of support bar 16 is substantially complementary to the portion of the ring 44a from which support bar 16 is outwardly spaced. Similarly, the shape of bar 24 is substantially complementary to the portion to the ring 44a from which the bar 24 is outwardly spaced.

A gap is defined between an inner surface of the bar 24 and the circumferential outer surface of ring 44a of the mirror assembly 18. A gap is also defined between an inner surface of support bar 16 and the circumferential outer surface of ring 44a. As illustrated, the gaps substantially circumscribes the entire circumferential perimeter ring 44a of mirror assembly 18 except for the positions where first and second mounting hubs 40, 42 are located. This arrangement permits the mirror assembly 18 to be freely rotated about an axis “X” (FIG. 6) that extends from the first mounting hub 40 to the second mounting hub 42.

The bar 24 together with the support bar 16 form a generally circular member that circumscribes the mirror assembly 18. The bar 24 is stationary at all times and the retaining assembly 26 moves circularly around a center point “CP” (FIG. 6). In other words, the retaining assembly 26 moves in an arc about center point “CP”. As indicated above, the bar 24 is shaped to be complementary to a portion of the circumferential outer surface of the mirror assembly 18, particularly to an upper region of the circumferential outer surface 44a of mirror assembly 18 when the mirror assembly 18 is vertically aligned with the bar 24 and support bar 16. The bar 24 and support bar 16 are aligned with the same plane and the mirror assembly is able to rotate about the center point “CP” which is in the same plane as the bar 24 and support bar 16.

Referring to FIGS. 5, 5A, 5B, and 6, an electronic device 100 may be engaged with retaining assembly 26. FIG. 5A shows clamping device 58 in an unexpanded position where the extender body 70 is retracted into the slider body 68 and the distance between the first pad 76 and second pad 78 is at a minimum distance “D”. FIG. 5B shows clamping device 58 in an expanded position where side wall 70a of extender body 70 has been moved in a direction “A” transversely away from second leg 68b of slider body 68. Applying this pulling force on side wall 70a increases the distance between the inner surface of side wall 70a and the inner surface of second leg 68b from the distance “D” to the distance “D1”. Moving side wall 70a in the direction “A” also stretches or extends the coil springs 74 (FIG. 4). The user may then place electronic device 100 into the gap defined between the inner surfaces of side wall 70a and second leg 68b. The back surface of device 100 is placed against front plate 84. The first side 100a of electronic device 100 will be proximate first pad 76 and the second side 100b will be proximate second pad 78. While holding electronic device 100 against front plate 84, the user will release side wall 70a. Coil springs 74 will tend to return to their at-rest length and as they do so, the side wall 70a will move toward second leg 68b. When first pad 76 contacts first side 100a of electronic device 100, electronic device 100 will be moved by side wall 70a towards second leg 68b. When second side 100b of electronic device 100 contacts second pad 78, electronic device 100 will be clamped between side wall 70a and second leg 68b and the user may release their hold on electronic device 100.

The user is able to utilize the user interface, i.e., the control panel 12h to control the mirror 10 and any electronic device 100 engaged with retaining assembly 26 and paired with mirror 10. Contact, depressing or otherwise manipulating the user interface is described hereafter. Depressing power button 29 allows the user to switch mirror 10 on when the user wishes to use mirror 10 and allows the user to switch mirror 10 off when they no longer wish to use mirror 10. Engaging power button 29 to switch mirror 10 on will cause power to be delivered to mirror 10 from the remote power outlet through an electric cable engaged with power port 12n. If a USB cable extends between USB port 12m and electronic device 100, then electronic device 100 will charge while being engaged to mirror 10. Holding the power button 29 down for a predetermined length of time, e.g. 3 seconds, will cause mirror 10 to pair with electronic device 100. The pairing may occur wirelessly, such as by BLUETOOTH® technology. Alternatively, if a cord extends between electronic device 100 and mirror 10, wired pairing may occur. Pairing enables the user to utilize the control panel 12h to activate, deactivate, operate, and control various functions of the electronic device 100. The control panel 12h also enables the user to control various functions of mirror 10.

Switching mirror 10 on will also cause power to be delivered to light array 52 through light power connector 48 (FIG. 3). Powering light array 52 will cause the LEDs within light array 52 to be activated and cause light to be emitted from array 52. The light will shine outwardly through the transparent, translucent, or opaque area 20b, 22b of one or both of the front mirror panel 20 and rear mirror panel 22 of mirror assembly 18. In one embodiment, light power connector 48 and/or the programming within PCB 34 will cause light to be emitted only from whichever mirror panel 20 or 22 is facing the user in front of the mirror 10. In one embodiment, light power connector 48 and/or the programming within PCB 34 will cause light to be simultaneously emitted from both of the mirror panels 20 and 22. Contacting the brightness button 30 on control panel 12h will enable the user to select the intensity of the light shining outwardly from areas 20b and/or 22b. The user will hold down brightness button 30 and then use the volume up button 33 to increase the brightness and intensity of light being emitted from light array 52. The user will down brightness button 30 and use the volume down button 31 to decrease the brightness and intensity of light being emitted from light array 52.

Control panel 12h is also utilized to control electronic device 100. The play pause button 28 is utilized to cause electronic device 100 to play or to pause. The volume up/shutter button 33 will increase the volume on the electronic device 100. The volume down/shutter button 31 will reduce the volume on electronic device 100.

FIG. 6 shows the retaining assembly 26 in three possible positions on bar 24. Retaining assembly 26 is moved along bar as described hereafter. Buttons 60m are utilized to move the locking mechanism on housing 54 between a locked position and an unlocked position. In particular, when slider buttons 60m are pushed inwardly toward the associated side wall 60d, 60e, the braking action of slider brakes 60j is substantially prevented and the locking mechanism is thereby effectively unlocked. When the braking action does not occur, the user is able to move housing 54 along bar 24 from a first position to a second position or vice versa. When inward pressure on slider buttons 60m is no longer applied, the slider brakes 60j return to their default position and their braking action is re-engaged. The locking mechanism is therefore locked and any further sliding motion of housing 54 along bar 24 is substantially prevented. This will be described in greater detail hereafter.

FIG. 4A shows slider brakes 60j in a locked position meaning that housing 54 is not able to move along bar 24 but is temporarily positioned in a set location on bar 24. As is evident from this figure, when slider brakes 60j are locked, the two slider brakes 60j are oriented at and acute angle α relative to each other. (Angle α is less than 90°.) Because slider brakes 60j are angled relative to each other, the slots 60j′ defined therein are not fully aligned with each other or with the slots 60h in lower housing section 60. The partial misalignment of these slots 60j′ and 60h prevents movement of housing 54 along bar 24 in either of a first direction “B” (FIG. 6) or a second direction “C”.

FIG. 4B shows slider brakes 60j in an unlocked position. Slider brakes 60j are moved from the locked position to the unlocked position by depressing the slider buttons 60m inwardly toward each other in the direction of arrows “E” (FIG. 9). Each slider button 60m has an end 60m′ that contacts a side wall of one of the slider brakes 60j. Depressing slider buttons 60m inwardly in the direction of arrow “E” causes the ends 60m′ to push the front end of each slider brake 60j inwardly toward the other slider brake 60j. As slider brakes 60j move inwardly toward each other, springs 60k become compressed. The inward movement causes slider brakes 60j to become oriented substantially parallel to each other as shown in FIG. 4B. The length of the part of each slider button 60m that extends into receptacle 60f controls the extent to which the two slider brakes 60j may be moved toward each other. When slider brakes 60j are parallel, the slots 60j′ on the two slider brakes 60j are fully aligned with each other and with the slots 60h in side walls 60d, 60e. The user is therefore able to move housing 54 along bar 24.

As soon as the user stops applying the inward depressing force to slider buttons 60m, springs 60k will return to their original, uncompressed condition and will push the front ends of slider brakes 60j outwardly away from each other in the opposite direction to arrows “E”. The slots 60j′ on slider brakes 60j will no longer be substantially aligned with each other and slider brakes 60j will, once again, lock housing 54 in a set position on bar 24.

It is therefore possible for a user to select anywhere along bar 24 for the positioning of housing 54. The user can simply place a thumb on one slider button 60m and an index finger on the other slider button 60m and pinch their thumb and index finger together and thereby apply the depressing force on buttons 60m. The user can then simply move their hand in an arc while continuing to depress buttons 60m in order to slide housing 54 along bar 24. In other words, the user may apply a gentle force in a first direction “B” to move retaining assembly 26 and thereby electronic device 100 toward first mounting hub 40 or may apply a gentle force in a second direction “C” to move retaining assembly 26 and thereby electronic device 100 toward second mounting hub 42. When the desired position of housing 54 is reached, the user will simply let go of the housing 54 and the housing 54 will be locked in place. The user is therefore able to readily adjust the position of their electronic device using one hand.

It will be understood that in other embodiments, slider buttons 60m may need to be pulled outwardly relative to the associated side walls 60d, 60e of the lower housing in order to stop the braking action of slider brakes 60j, i.e., in order to unlock the locking mechanism. Stopping the outward pulling motion on the buttons will then allow those buttons to return to their default position where braking action of slider brakes 60j occurs once again.

It will be understood that the electronic device 100 may be engaged with retaining assembly 26 before retaining assembly 26 is moved along bar 24 or after retaining assembly 26 is moved along bar 24. Any time the user wishes to adjust the position of electronic device to capture a better shot, they can simply depress buttons 60m and move retaining assembly 26 to a new position on bar 24. Releasing the buttons 60m at any time will cause retaining assembly 26 to be locked in that specific desired position. Because the retaining assembly 26 and bar 24 are at eye level it is very quick and easy for the user to make immediate adjustments to the position of electronic device 100. Additionally, because control panel 12h is on the base 12 of mirror 10 and therefore readily accessible and in eye-view, the user can quickly and easily adjust light brightness of the light illuminating their face, control the filming by the electronic device, control the volume of sound being recorded or played, and control any other of the functions of electronic device 100.

Additionally, because retaining assembly 26 includes two ball joints, i.e., first socket 62c and first ball 56c and second socket 68c and second ball 56b, the user is able to readily rotate and adjust the position of electronic device 100 as each ball joints on the ends of shaft 56a allows for a universal wide angle of rotation of electronic device 100. This feature helps the user tilt and rotate electronic device 100 to an optimum position and orientation to capture the shot of the user's face or head that they desire. The rotational motion of the ball joints of ball arm 56 in combination with the rotation afforded by bar 24 provides the user with the opportunity to adjust the orientation of electronic device 100 through about 350 degrees because of the presence of the two ball joints.

FIG. 7 shows an alternative retaining assembly, generally indicated at 126, that may be utilized instead of retaining assembly 26. Retaining assembly 126 includes the same housing 54 and in some embodiments, the same ball arm assembly 56 as is utilized to operatively engage retaining assembly 26 with mirror assembly 18. However, instead of including clamping device 58, retaining assembly 126 comprises any other suitable holder body. One suitable holder body is a clip for engaging an electronic device to housing 54, such as the clip 186 which is illustrated as being engaged with the ball arm assembly 56. The specific clip 186 shown in FIG. 7 is disclosed in U.S. Design Pat. D818,808 (Barnett) and is suitable for engaging a grip for an electronic device such as the grip sold under the trademark POPSOCKET® and disclosed in U.S. Pat. No. 10,463,3116. (POPSOCKET® is a registered trademark of PopSockets LLC of Boulder Colo. Design Pat. D818,808 and utility patent U.S. Pat. No. 10,463,311 are assigned to PopSockets LLC of Boulder Colo.)

The clip 186 may be provided with a socket similar to second socket 68c on retaining assembly 26 and be engaged with first ball 56b on ball arm assembly 56. In other instances, ball arm assembly 56 may be modified so that first ball 56b is omitted and clip 186 is secured at the end of shaft 56a in some other way. It will be understood that retaining assembly 126 is used in substantially an identical manner to retaining assembly 26.

It will be understood that more than one retaining assembly 26 may be provided on bar 24. If more than one retaining assembly 26 is thus provided, more than one electronic device may be engaged with mirror 10. For example, two separate smartphones may be retained in separate holding assemblies 26 or one smartphone and one tablet may be retained in separate holding assemblies 26. A second retaining assembly 26 may capture and hold an additional light source to mirror 10. PCB 34 may be provided with programming that enables both singlepoint and multipoint pairing of mirror 10 with one electronic device or with more than one electronic device, respectively, depending on how many holding assemblies 26 are engaged with bar 24.

It will further be understood that support bar 16 may also be utilized as a bar in addition to bar 24 or instead of bar 24. In one embodiment (not shown), a clamping device will be used that has slots similar to slots 60h but with a cross-sectional shape that is complementary to the cross-section of support bar 16. If support bar 16 is used as a bar then the clamping device engaged therewith may be able to travel between first mounting hub 40 and support hub 14e or between second mounting hub 42 and support hub 14e.

It will be understood that mirror 10 may be utilized on its own without engaging an electronic device 100 therewith. Control panel 12h may be utilized to illuminate light array 52 as has been previously described herein. The user is able to rotate mirror assembly 18 about axis “X” to present either first mirror panel 20 or second mirror panel 22 at the front of mirror 10. The user will apply their makeup or do their hair and then switch off the light array 52 using control panel 12h.

A user may use mirror 10 to charge their electronic device 100, e.g., their cell phone. In this instance, the light array 52 may or may not be activated. A cord may be extended between the smartphone and the USB port 12n to enable charging of the smartphone.

A user may use mirror to take a selfie or shoot a video with an electronic device 100, such as a smartphone or tablet. Said method comprises temporarily securing electronic device 100 in a retaining assembly 26 (or 126) provided on a makeup mirror 10; pairing a processor (provided on PCB 34) on the makeup mirror 10 with the electronic device 100; providing a bar 24 that is spaced outwardly away from an outer perimeter 44a of a mirror assembly 18 of the makeup mirror 10; engaging the retaining assembly 26 with the bar 24; moving the retaining assembly 26 relative to the bar 24 from a first position e.g., proximate first mounting hub 40, to a second position, e.g., proximate second mounting hub 42; activating the electronic device 100 using a user interface e.g. using control panel 12h provided on the mirror 10; and shooting a selfie or a video with a camera provided on the electronic device 100 once the electronic device is activated. The method may further include activating a light array 52 provided on the mirror assembly 18 using the user interface 12h. The method may further comprise adjusting a level of light emitted by the light array 52 using the user interface 12h. The method may further include playing and/or pausing the electronic device 100 using the user interface by pressing the pause/play button 28. The method may further include adjusting a level of sound recorded by or played by the electronic device 100 using the user interface 12h (using volume up and volume down buttons 33, 31). The moving of the retaining assembly 26 relative to the bar 24 may be preceded by disengaging a locking mechanism (slider brakes 60j, slider springs 60k, and buttons 60m) on the retaining assembly 26 and may be followed by re-engaging the locking mechanism. The moving of the retaining assembly 26 relative to the bar 24 includes passing the retaining assembly 26 over an upper region and/or a side region of the mirror assembly 18. The method may further include adjusting an angle of tilt of the electronic device 100 relative to a housing 54 of the retaining assembly 26. The adjusting may further include moving the electronic device 100 utilizing at least one ball joint 62c, 66, 56c or 68c, 72, 56b provided on the retaining assembly 26.

The electronic device 100 is only temporarily engaged with mirror 10 if the user wishes to take a selfie or shoot a video with the electronic device while they are applying makeup or styling their hair. When the user so desires, the electronic device 100 can be removed from the retaining assembly 26 by pulling side wall 70d in a direction away from second leg 68b.

It will be understood that in some embodiments, the retaining assembly 54 may be operatively engaged with the mirror assembly 18 but at least a portion of the support assembly may be omitted. In this instance, the mirror assembly 18 will be a hand-held mirror that may be utilized to shoot selfies or videos. In one embodiment, the base 12 of the support assembly may be omitted. In one embodiment, the base 12 and the support shaft 14 may be omitted. On one embodiment, the base 12, the support shaft 14 and the support bar 16 may be omitted.

It will further be understood that control panel 12h may be provided on a different part of makeup mirror 10 from the embodiment illustrated in FIGS. 1-7. In one embodiment, the control panel 12h may be provided on mirror assembly 18 and the associated PCBs and other components that enable control panel 12h to control one or more functions of mirror assembly 18 and/or electronic device 100, may be housed within an interior of the mirror assembly 18.

It will further be understood that base 12 as disclosed in FIGS. 1-7 is configured to rest upon a horizontal flat surface such as a vanity top. In other words, makeup mirror 10 is a free-standing makeup mirror. In other embodiments, however, the base 12 of the support assembly may, instead, be configured as a mounting bracket which secures the mirror assembly 10 to a support structure. For example, the base of support assembly may be configured as a mounting bracket that may be secured to a vertical wall with fasteners. In other embodiments, the base of the support assembly may be a clamping device that clamps onto a horizontal surface, such as a vanity, or a vertical surface, such as a post or piece of furniture. If the mirror assembly is to be secured to a vertical surface, the rigid support shaft 14 illustrated in the attached figures may be replaced by a telescoping shaft or with any other extendable type of connector that links the base and the mirror assembly 18 with each other and which will all the mirror assembly to be moved outwardly from the vertical surface for use and then moved back towards the vertical surface when the user is finished doing their makeup or styling their hair. If the base is differently configured from base 12, then the control panel 12h as associated electronic components may be provided at a different location on makeup mirror 10, such as on the mirror assembly 18.

It will be further understood that while bar 24 has been shown as being located substantially circumscribing a portion of the outer surface 44a of mirror assembly 18, other configurations of the bar with which the retaining assembly 58 is engaged may be utilized instead. For example, one or more bars may be used that extend radially outwardly from the outer surface 44a of the mirror assembly 18 in a pattern similar to spokes on a wheel. In other instances, the bar may be omitted and the retaining assembly 58 may be directly engaged with the wall 44 of the mirror assembly. For example, tracks may be provided on the outer surface 44a and the housing 54 may be operatively engaged with those tracks.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors. Furthermore, the instructions or software code can be stored in at least one non-transitory computer-readable storage medium.

The user interface provided in mirror 10 may include display screens for visual presentation of output and speakers or other sound generating devices for audible presentation of output. Information may be input utilizing keyboards or control panels, pointing devices such as mice, touch pads, and digitizing tablets. As another example, information may be input through speech recognition or in other audible format.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single processor, but may be distributed in a modular fashion amongst a number of different processors to implement various aspects of the present disclosure.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A makeup mirror comprising:
a mirror assembly including a mirror; and
a retaining assembly operatively engaged with the mirror assembly in such a way that the retaining assembly is movable relative to the mirror, and wherein said retaining assembly is adapted to hold an electronic device.

2. The makeup mirror as defined in claim 1, further comprising:
a bar extending outwardly from the mirror assembly; wherein the retaining assembly is operatively engaged with the bar.

3. The makeup mirror as defined in claim 2 wherein the retaining assembly is selectively movable between a first position and a second position relative to the bar.

4. The makeup mirror as defined in claim 3, wherein the bar is spaced a distance outwardly from an outer surface of the mirror assembly and the bar circumscribes at least a portion of the outer surface of the mirror assembly.

5. The makeup mirror as defined in claim 3, further comprising a locking mechanism selectively movable between a locked position and an unlocked position, wherein when the locking mechanism is in the locked position, motion of the retaining assembly relative to the mirror is substantially prevented, and wherein when the locking mechanism is in the unlocked position, the retaining assembly is movable relative to the mirror in one of a first direction and a second direction.

6. The makeup mirror as defined in claim 1, further comprising:
a support assembly adapted to contact a surface; wherein the mirror assembly is operatively engaged with the support assembly and is retained by the support assembly a distance away from the surface.

7. The makeup mirror as defined in claim 1, wherein the retaining assembly includes a clamping device.

8. The makeup mirror as defined in claim 2, wherein the retaining assembly includes a clamping device and the clamping device comprises:
a housing operatively engaged with the bar;
a ball arm assembly operatively engaged at a first end with the housing; wherein the ball arm assembly is rotatable relative to housing; and
a holder body operatively engaged with a second end of the ball arm assembly; and wherein the holder body is rotatable relative to the ball arm assembly.

9. The makeup mirror as defined in claim 1, further comprising:
a processor;
programming provided in the processor, said programming being adapted to enable pairing of the makeup mirror with the electronic device retained by retaining assembly; and
a user interface operatively engaged with the processor, wherein the user interface is actuated to enable control of the electronic device and of the mirror.

10. The makeup mirror as defined in claim 9, further comprising a light source provided on the mirror assembly, said light source being operatively engaged with the processor, and being operatively controlled via the user interface.

11. In combination:
an electronic device; and
a makeup mirror, said makeup mirror including:
a mirror assembly including a mirror; and
a retaining assembly engaged with the mirror assembly and being selectively movable relative thereto, said retaining assembly being configured to temporarily secure the electronic device to the mirror assembly.

12. The combination as defined in claim 11, further comprising a bar operatively engaged with the mirror assembly, wherein the retaining assembly is engaged with the bar and is movable relative to the bar and thereby relative to the mirror assembly.

13. The combination as defined in claim 11, further comprising:
a processor;
programming provided within the processor and being operable to control one or more functions of the electronic device and one of more functions of the mirror assembly; and
a user interface operatively engaged with the processor; wherein the user interface is operable to control the one or more functions of the electronic device and the one or more functions of the mirror assembly.

14. A method of taking a selfie or shooting a video with an electronic device, said method comprising:
providing a makeup mirror including a mirror assembly that has a mirror;
providing a bar on the mirror assembly a distance outwardly from the mirror;
providing a retaining assembly on the bar; and
temporarily securing an electronic device with the retaining assembly.

15. The method as defined in claim 14, further comprising:
circumscribing at least a portion of the mirror assembly with the bar.

16. The method as defined in claim 14, further comprising:
moving the retaining assembly relative to the bar from a first position to a second position.

17. The method as defined in claim 16, wherein the moving of the retaining assembly relative to the bar is preceded by disengaging a locking mechanism.

18. The method as defined in claim 14, further comprising:
providing a support assembly on the makeup mirror, wherein the support assembly extends outwardly from the mirror assembly; and
standing a base of the support assembly on a flat surface.

19. The method as defined in claim 14, further comprising:
pairing a processor on the makeup mirror with the electronic device;
activating the electronic device using a user interface provided on the mirror assembly; and
shooting a selfie or a video with a camera provided on the electronic device once the electronic device is activated.

20. The method as defined in claim 19, further comprising:
activating and controlling a light array provided on the mirror using the user interface.
